(19) United States
(12) Patent Application Publication
(10) Pub. No.: US 2008/0281737 A1
(43) Pub. Date: Nov. 13, 2008

(54) System and Method for Authenticating the Identity of a User

(75) Inventor: Alfredo C. Fajardo, Singapore (SG)

Correspondence Address: INTELLECTUAL PROPERTY LAW GROUP LLP, 12 SOUTH FIRST STREET, SUITE 1205, SAN JOSE, CA, 95113, US

(73) Assignee: VERITAS MOBILE SOLUTIONS PTE. LTD., Singapore (SG)

(21) Appl. No.: 10/597,628

(22) PCT Filed: Jan. 28, 2005
(86) PCT No.: PCT/SG2005/000026

§ 371 Date: Jul. 16, 2008

(30) Foreign Application Priority Data
Feb. 5, 2004 (SG) 200400555-9

(51) Int. Cl. G06Q 40/00; H04L 9/32

(52) U.S. Cl. 705/35; 726/6; 713/184

(57) ABSTRACT

A system for authenticating the identity of a user comprising a user and an authenticating party, where the user enters identifying information to a web page associated with the authenticating party along with details of a communication identifier, the authenticating party generates a unique passkey and sends a communications message including the unique passkey to the user by way of the communication identifier, the user then operable to enter a passkey using an appropriate mechanism provided for at the web page and where the authenticating party authenticates the identity of the user in accordance with the result of a comparison between the passkey entered via the web page and the generated unique passkey. The system can also be performed by entering information and receiving information via a second destination address. Further embodiments describe a system for transferring credit of a mobile phone or SIM card to a new mobile phone on authentication of the identity of a user.

### FIELD OF THE INVENTION

The present invention relates to a system and method for authenticating the identity of a user. The invention is particularly useful for, but not limited to, authenticating the identity of a pre-paid mobile phone customer when said user has requested the transfer of their pre-paid balance amount following loss or damage of their mobile phone or SIM card. Other uses relate to other services whereby the pre-paid mobile phone number is used as a quasi-account number for various financial and currency accounts, whereby a balance is kept, and funds may be sent out and received.

### BACKGROUND ART

The following discussion of the background to the invention is intended to facilitate an understanding of the present invention. However, it should be appreciated that the discussion is not an acknowledgment or admission that any of the material referred to was published, known or part of the common general knowledge of the person skilled in the art in any jurisdiction as at the priority date of the application.

The world is moving towards a true m-commerce arrangement where the amount credited to a mobile phone (hereafter referred to as “load”) is used as currency. At the same time, more and more people are driven towards being a pre-paid mobile phone customer due to the convenience of acquiring such type of account and for some, as this arrangement provides anonymity.

The problem with this arrangement and a problem with pre-paid mobile phone use in general, is one of customer authentication. In current arrangements, when a pre-paid mobile phone customer loses or damages their mobile phone or SIM card (as the case may be foremost GSM mobile phone systems), the customer also loses their identity in the eyes of their mobile phone carrier. This also means that the pre-paid mobile phone carrier also loses their accrued load. In the case of a pre-paid mobile phone carrier who is a merchant engaging in m-commerce transactions, this can amount to a loss of several thousands of dollars.

One means of overcoming this arrangement is to require the pre-paid mobile phone customer to complete forms which provide the information necessary to link the customer's true identity to their mobile phone. However, this solution negates the attractiveness of convenience and anonymity that have been key factors in the growth of pre-paid mobile phone customers. For those not concerned with anonymity, this solution is not ideal as some customers are always adverse to forms or do not have the time to complete such forms.

It is an object of the present invention to provide a simplified means of authenticating a user's identity that alleviates, in whole or in part, some of the problems mentioned above.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of the invention there is provided a system for authenticating the identity of a user comprising:
a user;
an authenticating party;
   where the authenticating party identifies the user through a first communication identifier and generates and sends a unique passkey to a second communication identifier associated with the user, the user thereafter being prompted to send a communications message including a passkey to a predefined destination and where upon receipt of the communications message, the authenticating party compares the generated unique passkey with the passkey included in the communications message and authenticates the identity of the user in accordance with the result of the comparison.

The communications message may be an e-mail, a SMS message, a data packet including data inputted by the user at a web page, or even a physical postal package sent to the user's home or shipping address.

In a situation where the authentication is required in the context of operation of a mobile phone, the authenticating party may be a carrier, an authorised agent of the carrier or a facilitator. In this context, the authentication procedure can be used as a means of authenticating a user's identity for the purposes of transferring load from a lost or damaged pre-paid mobile phone or SIM card to a new pre-paid mobile phone.

Ideally, the system provides a mechanism by which the user can record the second communication identifier prior to making use of the authentication procedure. This mechanism may comprise the user sending a communications message to the authenticating party containing a first passkey. The authenticating party then updates the user's corresponding user account to include the first passkey before requesting the user to provide details of the second communication identifier. The authenticating party then sends a message to the second communication identifier. This message contains a second passkey which the user is required to send to a pre-defined location. This second passkey is also associated with the user's corresponding user account to allow the second passkey sent by the user to the pre-defined location to be verified. Upon verification, the user's corresponding user account is again updated to include the second communication identifier. Alternative mechanisms that incorporate all or part of the features of the mechanism described previously in this paragraph may also be implemented.

The passkeys may be alphabetic, alphanumeric or numeric in format. The passkeys may also be modified for security purposes, for example, by being encrypted or slightly distorted.

The predefined location and predefined destination may be an e-mail address, a mobile application short-code or postal address.

It is preferable that the first communication identifier be a mobile phone number and the second communication identifier be an e-mail address because of their uniqueness and the fact that each identifier typically has a single owner. However, it is possible to create alternative arrangements where the communication identifiers could be an instant messenger address, an alternative telephone number, a web page/IP address or postal address.

In situations where the user cannot be authenticated after one or more attempts, the authenticating party may take action to prevent further attempts at authentication until the user contacts the authenticating party and satisfies them as to their identity through an additional security procedure.

In accordance with a second aspect of the invention there is provided a user seeking authentication of their identity by an authenticating party, the user being identified by the authenticating party through a first communication identifier and thereafter receiving a unique passkey generated by the authenticating party by way of a second communication identifier recorded with the authenticating party as being applicable to that user, the user thereafter sending a communications message including a passkey to a predefined destination and the authenticating party thereafter comparing the generated unique passkey with the passkey included in the user's communications message and authenticating the identity of the user in accordance with the result of the comparison.

In accordance with a third aspect of the invention there is provided an authenticating party capable of authenticating the identity of a user, the authenticating party identifying the user through a first communication identifier; generating and sending a unique passkey to the user through a second communication identifier recorded with the authenticating party as being applicable to that user; receiving a communications message from the user including a passkey at a predefined destination and authenticating the identity of the user in accordance with the result of a comparison between the generated unique passkey and the passkey included in the user's communications message.

In accordance with a fourth aspect of the invention there is provided a method for authenticating the identity of a user comprising:
identifying the user through a first communication identifier;
generating and sending a unique passkey to a second communication identifier associated with the user;
receiving a communications message at a predefined destination from the user including a passkey; and
authenticating the identity of the user in accordance with the results of a comparison between the passkey in the communications message and the generated unique passkey.

In accordance with a fifth aspect of the invention there is provided a system for authenticating the identity of a user comprising:
a user;
an authenticating party;
   where the user enters identifying information to a web page associated with the authenticating party along with details of a second communication identifier, the authenticating party generates a unique passkey and sends a communications message including the unique passkey to the user through the second communication identifier, the user then enters a passkey to the web page and the authenticating party authenticates the identity of the user in accordance with the results of a comparison between the passkey entered at the web page and the generated unique passkey.

In accordance with a sixth aspect of the invention there is provided a user seeking authentication of their identity by an authenticating party, the user being identified by the authenticating party through information entered at a web page and thereafter receiving a unique passkey generated by the authenticating party by way of a second communication identifier recorded with the authenticating party as being applicable to that user, the user thereafter entering a passkey at the web page and the authenticating party thereafter comparing the generated unique passkey with the passkey entered at the web page and authenticating the identity of the user in accordance with the result of the comparison.

In accordance with a seventh aspect of the invention there is provided an authenticating party capable of authenticating the identity of a user, the authenticating party identifying the user through information entered at a web page; generating and sending a unique passkey to the user through a second communication identifier recorded with the authenticating party as being applicable to that user; receiving a passkey from the user entered at the web page and authenticating the identity of the user in accordance with the result of a comparison between the generated unique passkey and the passkey entered at the web page.

In accordance with an eighth aspect of the invention there is provided a method for authenticating the identity of a user comprising:
identifying the user through information entered at a web page;
generating and sending a unique passkey to a second communication identifier associated with the user;
receiving a passkey entered at the web page; and
authenticating the identity of the user in accordance with the results of a comparison between the passkey entered at the web page and the generated unique passkey.

In accordance with a ninth aspect of the invention there is provided a system for transferring the credit of a mobile phone or SIM card to a new mobile phone on authentication of the identity of a user comprising:
a user;
an authenticating party; and
a mobile phone carrier who operates the telecommunications network used by the mobile phone and new mobile phone.
   where the authenticating party identifies the user through information provided in a communication message sent from the new mobile phone and generates and sends a unique passkey to a second communication identifier associated with the user, the user thereafter being prompted to send a communications message including a passkey to a predefined destination and where upon receipt of the communications message, the authenticating party compares the generated unique passkey with the passkey included in the communications message and authenticates the identity of the user in accordance with the result of the comparison and where, once the user has been authenticated, the authenticating party authorises the mobile phone carrier to add the amount of credit associated with the mobile phone to the credit associated with the new mobile phone.

In accordance with a tenth aspect of the invention there is provided a system for transferring the credit of a mobile phone or SIM card to a new mobile phone on authentication of the identity of a user comprising:
a user;
an authenticating party; and
a mobile phone carrier who operates the telecommunications network used by the mobile phone and new mobile phone.
   where the authenticating party identifies the user through information entered at a web page, including information as to the telephone number of the new mobile phone, and generates and sends a unique passkey to the new mobile phone by an appropriate communications message, the user thereafter being prompted to enter a passkey at the web page and where upon entering the passkey at the web page, the authenticating party compares the generated unique passkey with the passkey entered at the web page and authenticates the identity of the user in accordance with the result of the comparison and where, once the user has been authenticated, the authenticating party authorises the mobile phone carrier to add the amount of the credit associated with the mobile phone to the credit associated with the new mobile phone.

Further embodiments of the invention include:
an authenticating party for use in a system for transferring the credit of a mobile phone or SIM card to a new mobile phone on authentication of the identity of a user according to the ninth or tenth embodiment;
methods for transferring the credit of a mobile phone or SIM card to a new mobile phone on authentication of the identity of a user; and
computer readable mediums having software recorded thereon for effecting a method for transferring the credit of a mobile phone or SIM card to a new mobile phone on authentication of the identity of a user.

### BRIEF DESCRIPTION OF THE DRAWINGS

The invention will now be described with reference to the following drawings, of which:

FIG. 1 is a schematic of a first embodiment of a system for authenticating the identity of a user.

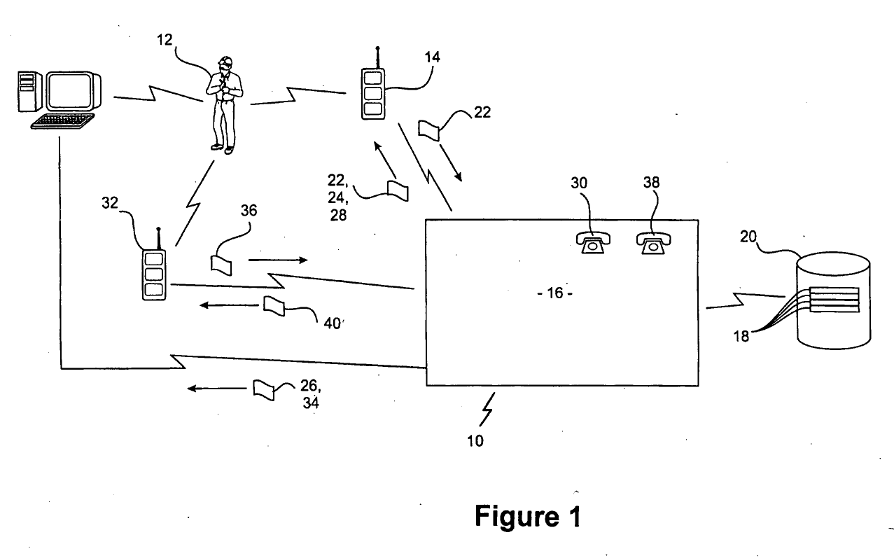

FIG. 2 is a schematic of a second embodiment of a system for authenticating the identity of a user.

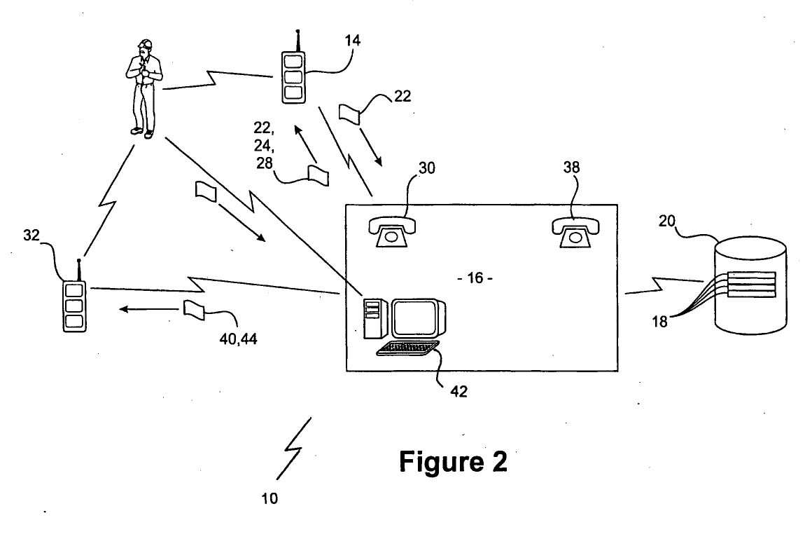

### BEST MODE(S) FOR CARRYING OUT THE INVENTION

In accordance with a first embodiment of the present invention there is provided a system 10 for authenticating the identity of a user 12 in order to facilitate the transfer of load from a lost or damaged prep-paid mobile phone or SIM card 14 to a new mobile phone 32 comprising:
user 12;
a pre-paid mobile phone 14;
a carrier 16;
a carrier account database 20;
a new mobile phone 32;

User 12 is the owner and/or possessor of pre-paid mobile phone 14 and new mobile phone 32. Pre-paid mobile phone 14 and new mobile phone 32 are adapted to operate using the telecommunications network owned and/or operated by carrier 16. Carrier 16 operates carrier account database 20. Carrier account database 20 is a database of user records 18.

Carrier 16 also operates, as part of their communication network, pre-determined mobile application shortcode 30 and application shortcode 38. Carrier 16, or an agent of carrier 16, operates web page 42.

The invention will now be described in the context of its most likely use.

When a user 12 activates a pre-paid mobile phone 14, the carrier 16 with which the pre-paid mobile phone 14 is associated creates a user record 18 in a carrier account database 20. The user record 18 contains the telephone number assigned to the pre-paid mobile phone 14 and the current load balance for the pre-paid mobile phone 14. The user record 18 is thereafter primarily referenced by the assigned telephone number field.

Following creation of the user record 18, the user 12 is prompted by the carrier 16 to enter a Personal Identification Number (“PIN”) to allow authorisation of secure transfers of load. In the preferred arrangement, this prompting takes the form of an SMS message 22 sent to the pre-paid mobile phone 14 to which the user 12 replies with the PIN number.

Upon receipt of the SMS message 22 containing the PIN number and the communication identifier, the carrier 16 operates to update the user record 18 to include the PIN as an additional field. Determining the appropriate user record 18 to update is achieved by this first process:
Identifying the telephone number of the pre-paid mobile phone 14 by means of caller identification;
Comparing the telephone number of each user record 18 in the carrier account database 20 with the identified telephone number until a match is found.

Once the PIN has been added to the user record 18, the carrier 16 prompts the user 12 to respond by SMS message 24 with an additional communication identifier.

The communication identifier is ideally an e-mail address because of its uniqueness and the fact that e-mail address typically have a single owner and it is in this context that the following examples will be described. However, in alternative arrangements, the communication identifier can be an instant messenger address, alternative telephone number or postal address.

Upon receipt of the SMS message 24 with the additional communication identifier, the carrier 16 operates to send an e-mail message 26 to the e-mail address entered as the additional communication identifier. The e-mail message 26 contains a unique passkey and a request for the user to send from the pre-paid mobile phone 14 an SMS message 28 containing only the unique passkey to a pre-determined mobile application shortcode 30. The passkey may be in numeric, alphabetic or alphanumeric format. A copy of the unique passkey is also temporarily associated with the user record 18 for verification purposes.

The user 12 then follows the instructions contained in the e-mail message 26, upon receipt of the e-mail or when they next check for e-mail sent to their e-mail address.

The SMS message 28 is received by the carrier 16 via the predetermined mobile application shortcode 30. The carrier 16 identifies the appropriate user record 18 according to the first process previously described. When the appropriate user record 18 has been identified, the carrier 16 compares the unique passkey associated with the user record 18 with the passkey the subject of SMS message 28.

If the two passkeys are identical, the appropriate user record 18 is again updated, this time to include the user's 12 communication identifier, ie. e-mail address, as an additional field. The user 12 can then be identified through both their mobile number and their communication identifier.

Where the two passkeys differ, the unique passkey associated with the user record 18 is discarded. The user 12 is then periodically requested to repeat the foregoing procedure until such time as the user's 12 corresponding user record 18 has a field recording a communication identifier.

Subsequent to this recording procedure, the user 12 can then seek to recover a load from a lost or damaged pre-paid mobile phone or SIM card 14 to a new mobile phone 32 in one of two ways.

In the first way, the user 12 calls a customer service line of the carrier 16 using their new mobile phone 32. The carrier 16 then identifies the corresponding user record 18 for the user 12—for example by requesting the user to enter in their previous mobile phone number and thereafter checking the entered number against the mobile phone number field of each user record 18 until a match is found. Once identified, an e-mail message 34 is sent to the e-mail address recorded as the user's 12 communication identifier. E-mail message 34 includes a newly generated unique passkey which may also be in numeric, alphabetic or alphanumeric format. E-mail message 34 may also include a prompt for user 12 to send by SMS message 36 the newly generated unique passkey to an application shortcode 38 using the new mobile phone 32.

Again, for verification purposes, a copy of the newly generated unique passkey is associated with the user's 12 corresponding user record 18.

Once the user 12 has sent the SMS message 36 to the application shortcode 38, the carrier 16 identifies the appropriate user record 18 according to the first process previously described. When the appropriate user record 18 has been identified, the carrier 16 compares the newly generated unique passkey associated with the user record 18 with the passkey the subject of SMS message 36.

If the two passkeys are identical, the carrier operates to update the user record 18 to change the mobile phone number field to reflect the new mobile phone number and thereby effect a transfer of load. The user 12 is then sent a SMS message 40 to the new mobile phone number informing them that the transfer was successful.

Where the two passkeys differ, the unique passkey associated with the user record 18 is discarded. The user 12 is then sent a SMS message 40 to the new mobile phone 32 informing them that the request was unsuccessful.

In the second way, the user 12 logs onto a web page 42. At the web page 42, the user 12 is asked to enter in the following information:
their communication identifier;
their PIN; and
their new mobile phone number.

The carrier 16 then receives the information the user 12 has entered into the web page 42. The carrier 16 then operates to identify the user's 12 corresponding user record 18 according to this second process:
Comparing the entered communication identifier with the communication identifier recorded for each user record 18;
If the communication identifiers match, adding the user record 18 to a further search list;
Comparing the entered PIN with the PIN recorded for each user record 18 in the further search list until such time as a match is found.

Once a matching record is found, an SMS message 44 is sent to new mobile phone 32. SMS message 44 includes a newly generated unique passkey which may be in numeric, alphabetic or alphanumeric format. SMS message 44 may also include a prompt for user 12 to return to web page 42 to enter the unique passkey.

Again, for verification purposes, a copy of the newly generated unique passkey is associated with the user's 12 corresponding user record 18.

Once the user 12 has entered the unique passkey via web page 42, the carrier 16 identifies the appropriate user record 18 according to the second process previously described. When the appropriate user record 18 has been identified, the carrier 16 compares the newly generated unique passkey associated with the user record 18 with the passkey entered via web page 42.

If the two passkeys are identical, the carrier operates to update the user record 18 to change the mobile phone number field to reflect the new mobile phone number and thereby effect a transfer of load. The user 12 is then sent a SMS message 40 to the new mobile phone number informing them that the transfer was successful.

Where the two passkeys differ, the unique passkey associated with the user record 18 is discarded. The user 12 is then sent a SMS message 40 to the new mobile phone 32 informing them that the request was unsuccessful.

It should be appreciated by the person skilled in the art that the above invention is not limited to the embodiments described. In particular,
The invention is not limited to situations involving pre-paid mobile phones. For example, even post-paid mobile phones may be used. Electronic wallets are created with the post-paid mobile phone as the central identifying medium; such electronic wallets do not necessarily contain loads, rather could be real currency as contained in one's bank account or even loads that are only intended for resale and not for own or personal use. The above process could easily be adapted for use in other situations requiring authentication of the identity of a user.
The need to transfer load may arise in situations other than loss or damage of a mobile phone or SIM card. For example, load may be transferred prior to the mobile phone with new SIM card being given as a gift or loan to another party. Furthermore, the need to transfer load may be a result of loss or damage of the SIM card of the mobile phone, rather than loss or damage of the mobile phone itself. As another example, the user may simply wish to re-assign current electronic wallets associated with a pre-paid mobile account to a post-paid mobile account, as post-paid accounts are much more secure and inexpensive to maintain for a heavy user. (Carriers can easily restore an old account unto a new SIM card for post-paid users, rendering the lost or damaged post-paid SIM card useless.)
The carrier 16 may be replaced with an agent or facilitator. In such an arrangement, the agent or facilitator may operate a modified carrier account database 20. In the modified carrier account database 20, each user record 18 omits details of the current load balance for the pre-paid mobile phone. As a result, when a user's 12 identity has been authenticated and a request made to transfer load from one pre-paid mobile phone to another, the agent or facilitator operates to transfer the load by making a series of mobile terminating calls or varying denominations against the first pre-paid mobile phone, crediting the account of the second pre-paid mobile phone with the denomination (minus commission).
Prompting the user 12 may take many forms and the invention should not be limited to any particular form of prompting. For example, the initial prompting of the user 12 may be by way of a notice in the pre-paid mobile phone 14 package asking the user to send a message or call a predetermined short code.
Similarly, the response provided by a user 12 to a prompt may take many forms and the invention should not be limited to any form of response. For example, response may be by e-mail, or by returning a simple form downloadable from web site 42 to the carrier 16 by post.
E-mail messages 28, 34 may be in plain text or HTML format. In HTML format, depiction of the unique passkey may be in a slightly distorted form or in graphic form for additional security purposes. The e-mail messages 28, 34 may also be encrypted for yet additional security.
If the user 12 fails in their attempt to transfer load, the user 12 may be also be sent a communication to their communication identifier informing them that a request to transfer load failed. Upon multiple failures of an attempt to transfer load, carrier 16 may take action to prevent further load requests from being processed and the corresponding pre-paid mobile phone from being used until such time as the user 12 contacts the carrier 16 and satisfies them as to their identity through an additional security procedure.

We claim:

1. A system for transferring credit associated with a mobile phone to a new mobile phone, said system including an authenticating party having access to user data including a communication identifier associated with said mobile phone, and arranged to authenticate the identity of a user of said mobile phone;
where the user enters identifying information included in said user data to a web page associated with the authenticating party along with details of a new communication identifier associated with said new mobile phone, the authenticating party generates a unique passkey and sends a communications message including the unique passkey to the user by way of the new communication identifier; whereafter the user then enters a passkey at the web page and when the authenticating party authenticates the identity of the user in accordance with the result of a comparison between the passkey entered via the web page and the generated unique passkey, the authenticating party authorises transfer of the credit.

2. A system as claimed in claim 1 where after authenticating the identity of the user, said authenticating party updates said user data to include the new communication identifier.

3. A system for transferring credit associated with a mobile phone to a new mobile phone, said system including an authenticating party having access to user data including a first communication identifier associated with said mobile phone, and arranged to authenticate the identity of a user of said mobile phone;
where the authenticating party identifies the user through information included in said user data including said first communication identifier sent from said new mobile phone and generates and communicates a unique passkey to a second communication identifier, the user thereafter being prompted to send a communications message including a passkey to a predefined destination address associated with the authenticating party and where, upon receipt of the communication message at the predefined destination address, the authenticating party compares the generated unique passkey with the passkey included in the communications message and authenticates the identity of the user in accordance with the result of the comparison, and authorises transfer of the credit on successful authentication of the identity of said user.

4. A system according to claim 3, where the user provides details of the first communication identifier and the second communication identifier to the authenticating party as an initial step.

5. A system according to claim 3 or 4 wherein after authenticating the identity of said user, said authenticating party updates said user data to include a new communication identifier associated with said new mobile phone.

6. A system according to any preceding claim where if the user cannot be authenticated after one or more attempts, the authenticating party prevents further attempts at authentication until the user contacts the authenticating party and satisfies the authenticating party as to their identity through an additional security procedure.

7. A system according to any preceding claim, where the user data comprises at least two of the following: a mobile phone number; an instant messenger address; an e-mail address; a fixed phone number; a facsimile number; a domain name; a static IP address; a postal address.

8. A system according to any preceding claim, where the communications messages are one of the following: an e-mail, a SMS message, a MMS message, a data packet including data inputted by the user at a web page, a physical postal package sent to the user's home or shipping address.

9. A system according to any preceding claim, where the passkey is alphabetic, alphanumeric or numeric in format.

10. A system according to any preceding claim, where the passkey is modified for security purposes.

11. A system according to claim 10, where the passkey is encrypted.

12. A system according to claim 10, where the passkey is distorted while still being recognisable.

13. A user application for a user of a mobile phone using a new mobile phone, said user application being provided to transfer credit from said mobile phone to said new mobile phone, said user application accessing an authenticating party having access to user data including a communication identifier associated with said mobile phone, the user entering identifying information included in said user data to a web page associated with the authenticating party along with details of a new communication identifier associated with said new mobile phone, the user thereafter receiving a communications message from the authenticating party via the new communication identifier, the communications message including a unique passkey generated by the authenticating party, and in response operable to enter a passkey using an appropriate mechanism provided for at the web page, the authenticating party thereafter comparing the generated unique passkey with the passkey entered via the web page and authenticating the identity of the user in accordance with the results of the comparison, and authorising transfer of the credit on successful authentication of the identity of said user.

14. A user application for a mobile phone user as claimed in claim 13 where after authenticating the identity of said user, said authenticating party updates said user data to include said new communication identifier.

15. A user application for a user of a mobile phone using a new mobile phone, said user application being provided to transfer credit from said mobile phone to said new mobile phone, said user application accessing an authenticating party having access to user data including a first communication identifier associated with said mobile phone the user being identified by the authenticating party through said first communication identifier and thereafter receiving a unique passkey generated by the authenticating party and communicated by way of a second communication identifier recorded with the user data, the user thereafter sending a communications message including a passkey to a predefined destination and the authenticating party thereafter comparing the generated unique passkey with the passkey included in the user's communication message and authenticating the identity of the user in accordance with the result of the comparison, and authorising transfer of the credit on successful authentication of the identity of said user.

16. A user application for a mobile phone user as claimed in claim 15 where after authenticating the identity of said user, said authenticating party updates said user data to include a new communication identifier associated with said new mobile phone.

17. An authenticating party for use in a system for transferring credit associated with a mobile phone to a new mobile phone, said authenticating party being capable of authenticating the identity of a user, the authenticating party having access to user data including a communication identifier associated with said mobile phone of the user, said authenticating party receiving identifying information from said user data and details of a new communication identifier of said new mobile phone by way of a web page associated with the authenticating party, generating and communicating a unique passkey via the new communication identifier and receiving a passkey entered by the user using an appropriate mechanism provided for at the web page and authenticating the identity of the user in accordance with the result of a comparison between the generated unique passkey and the passkey entered by the user via the web page, and transferring said credit on successful authentication of the identity of said user.

18. An authenticating party as claimed in claim 17 where after authenticating the identity of said user, said authenticating party updates said user data to include said new communication identifier.

19. An authenticating party for use in a system for transferring credit associated with a mobile phone to a new mobile phone, said authenticating party being capable of authenticating the identity of a user, the authenticating party having access to user data including a first communication identifier associated with said mobile phone of the user, said authenticating party identifying the user through said user data including said first communication identifier sent from said new mobile phone; generating and communicating a unique passkey to the user through a second communication identifier recorded with the authenticating party as being applicable to that user; receiving a communications message from the user including a passkey at a predefined destination address and authenticating the identity of the user in accordance with the result of a comparison between the generated unique passkey and the passkey included in the user's communication message, and transferring said credit on successful authentication of the identity of said user.

20. An authenticating party as claimed in claim 19 where after authenticating the identity of said user, said authenticating party updates said user data to include a new communication identifier associated with said new mobile phone.

21. A method for transferring credit associated with a mobile phone to a new mobile phone comprising:
identifying the user through user data information including a communication identifier associated with a mobile phone entered at a web page, said user data being recorded in a database connected with said web page;
generating and sending a unique passkey to a new communication identifier associated with a new mobile phone of the user;
receiving a passkey entered at the web page;
authenticating the identity of a user in accordance with the results of a comparison between the passkey entered at the web page and the generated unique passkey; and
authorising transfer of the credit on successful authentication of the identity of said user.

22. A method for transferring credit as claimed in claim 21 comprising, after authenticating the identity of said user, the step of updating said user data to include said new communication identifier.

23. A method for transferring credit associated with a mobile phone of a user to a new mobile phone, when the user is using a new mobile phone, said method comprising:
identifying the user through user data including a first communication identifier sent from said new mobile phone;
generating and sending a unique passkey to a second communication identifier associated with the user;
receiving a communications message at a predefined destination from the user including a passkey;
authenticating the identity of the user in accordance with the results of a comparison between the passkey in the communications message and the generated unique passkey; and
authorising transfer of the credit on successful authentication of the identity of said user.

24. A method for transferring credit as claimed in claim 23 comprising, after authenticating the identity of said user, the step of updating said user data to include a new communication identifier associated with said new mobile phone.

25. A computer readable medium having software recorded thereon, said software including:
identifying means for identifying the user through user data information including a communication identifier associated with a mobile phone entered at a web page, said user data being recorded on an accessible database;
communication means for generating and sending a unique passkey to a new communication identifier associated with a new mobile phone of the user; and receiving a passkey entered at the web page;
authenticating means for authenticating the identity of a user in accordance with the results of a comparison between the passkey entered at the web page and the generated unique passkey; and
authorisation means for authorising transfer of credit associated with said mobile phone to be associated with said new mobile phone, on successful authentication of the identity of said user.

26. A computer readable medium having software recorded thereon as claimed in claim 25, said software including updating means to update said user data recorded on said database to include said new communication identifier.

27. A computer readable medium having software recorded thereon, said software including:
identifying means for identifying a user having a mobile phone when the user is using a new mobile phone, through user data including a first communication identifier sent from said new mobile phone;
communication means for generating and sending a unique passkey to a second communication identifier associated with the user; and receiving a communications message at a predefined destination sent from the new mobile phone by the user including a passkey;
authenticating means for authenticating the identity of the user in accordance with the results of a comparison between the passkey in the communications message and the generated unique passkey; and
authorisation means for authorising transfer of credit associated with said mobile phone to be associated with said new mobile phone, on successful authentication of the identity of said user.

28. A computer readable medium having software recorded thereon as claimed in claim 27, said software including updating means to update said user data recorded on said database to include a new communication identifier associated with said new mobile phone.

29. A system for transferring credit of a mobile phone or SIM card to a new mobile phone on authentication of the identity of a user comprising:
a user;
an authenticating party; and
a mobile phone carrier who operates the telecommunications network used by the mobile phone or SIM card and the new mobile phone,
where the authenticating party identifies the user through information provided in a communication message sent from the new mobile phone and generates and communicates a unique passkey to a second communication identifier associated with the user, the user thereafter being prompted to send a communications message including a passkey to a predefined destination and where upon receipt of the communications message, the authenticating party compares the generated unique passkey with the passkey included in the communications message and authenticates the identity of the user in accordance with the result of the comparison and where, once the user has been authenticated, the authenticating party authorizes the mobile phone carrier to add the amount of credit associated with the mobile phone or SIM card to the credit associated with the new mobile phone.

30. A system for transferring credit of a mobile phone or SIM card to a new mobile phone on authentication of the identity of a user comprising:
a user;
an authenticating party; and
a mobile phone carrier who operates the telecommunications network used by the mobile phone or SIM card and new mobile phone,
where the authenticating party identifies the user through information entered at a web page, including information as to the number of the new mobile phone, and generates and communicates a unique passkey to the new mobile phone by an appropriate communications message, the user thereafter being prompted to enter a passkey at the web page and where upon entering the passkey at the web page, the authenticating party compares the generated unique passkey with the passkey entered at the web page and authenticates the identity of the user in accordance with the result of the comparison and where, once the user has been authenticated, the authenticating party authorizes the mobile phone carrier to add the amount of credit associated with the mobile phone or SIM card to the credit associated with the new mobile phone.

31. A system for transferring credit of a mobile phone or SIM card to a new mobile phone on authentication of the identity of a user according to claim 29 or claim 30, where the information by which the authenticating party identifies the user includes the number of the mobile phone or SIM card.

32. A system for transferring credit of a mobile phone or SIM card to a new mobile phone on authentication of the identity of a user according to claim 29 or claim 31, as dependent on claim 29, where the predefined destination is an e-mail address and the communications message is an e-mail message.

33. A system for transferring credit of a mobile phone or SIM card to a new mobile phone on authentication of the identity of a user according to any one of claims 29 to 32, where the mobile phone carrier adds the amount of credit associated with the mobile phone or SIM card to the credit associated with the new mobile phone by changing a user's account with the mobile phone carrier associated with the mobile phone or SIM card to record the new mobile phone number and thereby associate the user's account with the new mobile phone number.

34. A system for transferring credit of a mobile phone or SIM card to a new mobile phone on authentication of the identity of a user according to any one of claims 29 to 32, where the authenticating party authorizes the mobile phone carrier to add the amount of credit associated with the mobile phone or SIM card to the credit associated with the new mobile phone by issuing a series of commands representative of the user having made a number of mobile terminating calls using the mobile phone or SIM card and issuing a series of commands representative of the user having made a credit payment on a user's account associated with the new mobile phone having a corresponding value to the value of the number of mobile terminating calls.

35. A system for transferring credit of a mobile phone or SIM card to a new mobile phone on authentication of the identity of a user according to any one of claims 29 to 34, where upon the user failing to authenticate their identity a preset number of times, the authenticating party prevents further requests to transfer credit of a mobile phone or SIM card to a new mobile phone until such time as the user satisfies the authenticating party as to their identity through an additional security procedure.

36. An authenticating party for use in a system for transferring credit of a mobile phone or SIM card to a new mobile phone on authentication of the identity of a user, the authenticating party operable to identify the user through information provided in a communication carrier sent from a new mobile phone, generate and communicate a unique passkey to a second communication identifier associated with the user and receive a communications message, at a predefined destination, including a passkey, the authenticating party thereafter authenticating the user on the basis of a comparison between the generated unique passkey and the passkey included in the communications message and, if the user is authenticated, authorize a mobile phone carrier who operates a telecommunications network used by the mobile phone or SIM card and the new mobile phone to add the amount of credit associated with the mobile phone or SIM card to the credit associated with the new mobile phone.

37. An authenticating party for use in a system for transferring credit of a mobile phone or SIM card to a new mobile phone on authentication of the identity of a user, the authenticating party operable to identify the user through information entered at a web page, including information as to the number of the new mobile phone, generate and communicate a unique passkey to the new mobile phone by an appropriate communications message and receive a passkey entered at the web page in response to the communications message, the authenticating party thereafter authenticating the user on the basis of a comparison between the generated unique passkey and the passkey entered at the web page and, if the user is authenticated, authorize a mobile phone carrier who operates a telecommunications network used by the mobile phone or SIM card and the new mobile phone to add the amount of credit associated with the mobile phone or SIM card to the credit associated with the new mobile phone.

38. A method for transferring credit of a mobile phone or SIM card to a new mobile phone on authentication of the identity of a user comprising:
identifying the user through information provided in a communication message sent from the new mobile phone;
generating and communicating a unique passkey to a second communication identifier associated with the user;
receiving a communications message including a passkey at a predefined destination;
comparing the generated unique passkey with the passkey included in the communications message;
authenticating the identity of the user in accordance with the result of the comparison; and
if authenticated, authorising the mobile phone carrier who operates the telecommunications network used by the mobile phone or SIM card and the new mobile phone to add the amount of credit associated with the mobile phone or SIM card to the credit associated with the new mobile phone.

39. A method for transferring credit of a mobile phone or SIM card to a new mobile phone on authentication of the identity of a user comprising:
identifying the user through information entered at a web page, including information as to the number of the new mobile phone;
generating and communicating a unique passkey to the new mobile phone by an appropriate communications message;
receiving a passkey entered at the web page in response to the communications message;
comparing the generated unique passkey with the passkey entered at the web page;
authenticating the identity of the user in accordance with the result of the comparison; and
if authenticated, authorising the mobile phone carrier who operates the telecommunications network used by the mobile phone or SIM card and the new mobile phone to add the amount of credit associated with the mobile phone or SIM card to the credit associated with the new mobile phone.

40. A computer readable medium having software recorded thereon for transferring credit of a mobile phone or SIM card to a new mobile phone on authentication of the identity of a user, the software comprising:
identification means for identifying the user through information provided in a communication message sent from the new mobile phone;
communications means for generating and communicating a unique passkey to a second communication identifier associated with the user, and receiving a communications message including a passkey at a predefined destination;
comparison means for comparing the generated unique passkey with the passkey included in the communications message;
authentication means for authenticating the identity of the user in accordance with the result of the comparison; and
transfer means for authorising the mobile phone carrier who operates the telecommunications network used by the mobile phone or SIM card and the new mobile phone to add the amount of credit associated with the mobile phone or SIM card to the credit associated with the new mobile phone, if the user's identity is appropriately authenticated.

41. A computer readable medium having software recorded thereon for transferring credit of a mobile phone or SIM card to a new mobile phone on authentication of the identity of a user, the software comprising:
identification means for identifying the user through information entered at a web page, including information as to the number of the new mobile phone;
communications means for generating and communicating a unique passkey to the new mobile phone by an appropriate communications message and receiving a passkey entered at the web page in response to the communications message;
comparison means for comparing the generated unique passkey with the passkey entered at the web page;
authentication means for authenticating the identity of the user in accordance with the result of the comparison; and
transfer means for authorising the mobile phone carrier who operates the telecommunications network used by the mobile phone or SIM card and the new mobile phone to add the amount of credit associated with the mobile phone or SIM card to the credit associated with the new mobile phone, if the user's identity is appropriately authenticated.
